(19) United States
(12) Patent Application Publication
(10) Pub. No.: US 2006/0018513 A1
(43) Pub. Date: Jan. 26, 2006

(54) Stereo vehicle-exterior monitoring apparatus

(75) Inventor: Yoshiyuki Sogawa, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/148,202

(22) Filed: Jun. 9, 2005

(30) Foreign Application Priority Data
Jun. 14, 2004 (JP) 2004-175198

(51) Int. Cl. G06K 9/00

(52) U.S. Cl. 382/106

(57) ABSTRACT

A stereo vehicle-exterior monitoring apparatus includes a stereo camera including a pair of infrared cameras and floodlight lamp and infrared lights. The Infrared lights light up a more distant place than that is lighted up by the floodlight lamp, or light up a closer place and wider angle of lighting than that is lighted up by the floodlight lamp so as to obtain a wider monitored area than that with the lighting by the floodlight lamp. The stereo camera shoots at least lighting ranges of the infrared lights for obtaining a distance data of subject present in the surrounding of the vehicle.

### CROSS REFERENCE TO RELATED APPLICATIONS

The disclosure of Japanese Application No. 2004-175198 filed on Jun. 14, 2004 including the specification, drawings and abstract is incorporated herein by reference in its entirety.

### BACKGROUND OF THE INVENTION

1. Field of the Invention

The present invention relates to a stereo vehicle-exterior monitoring apparatus that monitors the surrounding of a vehicle thereof by using stereo cameras including a pair of infrared cameras.

2. Description of the Related Art

For example, Japanese Patent Publication JP-A-2001-344597 discloses a stereo monitoring apparatus having a pair of infrared cameras in order to achieve higher monitoring accuracy during night flight of an airplane. Japanese Patent Publication JP-A-2003-217319 discloses a night-vision equipment that provides a night vision of the front part of a vehicle thereof lighted by a monocular infrared camera with both visible light and infrared light. The night-vision equipment separates light emitted from a light source in a headlight into visible light and infrared light and irradiates the infrared light to a more distant place than that is lighted by visible light. Thus, the front part of the vehicle can have an area irradiated only by infrared light outside of the area irradiated with visible light. Under this condition, the monocular infrared camera that receives infrared light can shoot a foresight of the vehicle, and the shot image is then displayed on a display device. Therefore, a driver can grasp an obstacle not only in an area irradiated with visible light but also in a farther place outside of the area through the displayed shot image.

An enlargement of a monitored area during night driving may be one of problems to be solved by a stereo outside monitoring apparatus mounted in a vehicle such as an automobile. A (low-beam) headlight mounted on a vehicle is defined so as to light up a closer range of the vehicle with consideration for a driver who is driving an oncoming vehicle. Under this lighting condition, the monitoring apparatus cannot recognize a subject present in a lighting range of the headlight but cannot recognize a subject outside of the range easily except that the subject itself emits light. As a result, the monitored range obtained during night driving is inevitably narrower than that of daytime driving.

This problem may be solved by a method in which an infrared camera is used as a stereo camera instead of a visible light camera, and an infrared auxiliary light is additionally provided for lighting up the front part of a vehicle thereof by both of the headlight and the infrared auxiliary light. However, even in this case, obtaining a monitored range during night driving similar to that of daytime driving is still difficult. This is because the left and right extreme vicinities of the vehicle still remain as blind spots when a more distant place is irradiated with infrared light than that is lighted up by the headlight, for example, even though the monitored range can be enlarged farther. Conversely, the monitored range can be enlarged farther when infrared light lights up a closer part than that is lighted up by the headlight at a wider angle of irradiation than that of the headlight because the infrared light does not reach a more distant place even though the blind spots can be resolved.

Notably, the problem is not limited to the front part of the vehicle. In other words, the same problem still exists even with, for example, the infrared auxiliary light in addition to the backlight when the rear part of the vehicle is monitored.

### SUMMARY OF THE INVENTION

The present invention was made in view of these circumstances, and it is an object of the present invention to provide a stereo vehicle-exterior monitoring apparatus that can achieve a wider monitored range even during night driving for higher accuracy of monitoring.

In order to achieve the object, according to a first aspect of the invention, there is provided a stereo vehicle-exterior monitoring apparatus including a floodlight lamp for lighting up the surrounding of a vehicle thereof, a plurality of infrared auxiliary lights for lighting up a more distant place by infrared light than that is lighted up by the floodlight lamp and for lighting up a closer place and wider angle of lighting by infrared light than that is lighted up by the floodlight lamp so as to obtain a wider monitored area than that with the lighting by the floodlight lamp only, stereo cameras including a pair of infrared cameras, the stereo cameras shooting at least a lighted range of the infrared auxiliary lights, a stereo image processing portion for calculating distance data by stereo-matching based on a pair of images shot by the stereo cameras, and a monitoring portion for monitoring a subject present in the surrounding of the vehicle based on the distance data output from the stereo image processing portion.

According to a second aspect of the invention, threre is provided a stereo vehicle-exterior monitoring apparatus including a floodlight lamp for lighting up the surrounding of a vehicle thereof, a first infrared auxiliary light for lighting up a more distant place by infrared light than that is lighted up by the floodlight lamp, a second infrared auxiliary light for lighting up a closer place and wider angle of lighting by infrared light than that is lighted up by the floodlight lamp, stereo cameras including a pair of infrared cameras, the stereo cameras shooting at least a lighting range of the first infrared auxiliary light and a lighting range of the second infrared auxiliary light, a stereo image processing portion for calculating distance data by stereo-matching based on a pair of images shot by the stereo cameras, and a monitoring portion for monitoring a subject present in the surrounding of the vehicle based on the distance data output from the stereo image processing portion.

According to a third aspect of the invention, there is provided a stereo vehicle-exterior monitoring apparatus including a floodlight lamp for lighting up the surrounding of a vehicle thereof, a first infrared auxiliary light for lighting up a more distant place by infrared light than that is lighted up by the floodlight lamp at right direction with respect to the direction of lighting by the floodlight lamp, a second infrared auxiliary light for lighting up a more distant place by infrared light than that is lighted up by the floodlight lamp at a left direction with respect to the direction of lighting by the floodlight lamp, stereo cameras including a pair of infrared cameras, the stereo cameras shooting at least a lighting range of the first infrared auxiliary light and a lighting range of the second infrared auxiliary light, a stereo image processing portion that calculates distance data by stereo-matching based on a pair of shot images output from the stereo cameras, and a monitoring portion that monitors a subject present in the surrounding of the vehicle based on the distance data output from the stereo image processing portion.

In these cases, the floodlight lamp may include a pair of headlights mounted on the front left and right parts of the vehicle.

According to the invention, a wider range of monitored area can be obtained for monitoring control even during night driving by increasing the monitored area obtained by a floodlight lamp such as a headlight and a backlight both farther and closer by using multiple infrared auxiliary lights. As a result, a further enhancement of accuracy of monitoring during night driving can be achieved.

### BRIEF DESCRIPTION OF THE DRAWINGS

FIG. 1 is a block construction diagram of a stereo vehicle-exterior monitoring apparatus according to the embodiment;

FIG. 2 is a top view of a vehicle including the stereo vehicle-exterior monitoring apparatus;

FIG. 3 is a diagram showing an irradiation pattern example;

FIG. 4 is an explanatory diagram of a monitored area by only the headlights;

FIG. 5 is an explanatory diagram of a monitored area by the headlights and infrared auxiliary lights; and

FIG. 6 is a diagram showing another irradiation pattern example.

### DESCRIPTION OF THE PREFERRED EMBODIMENTS

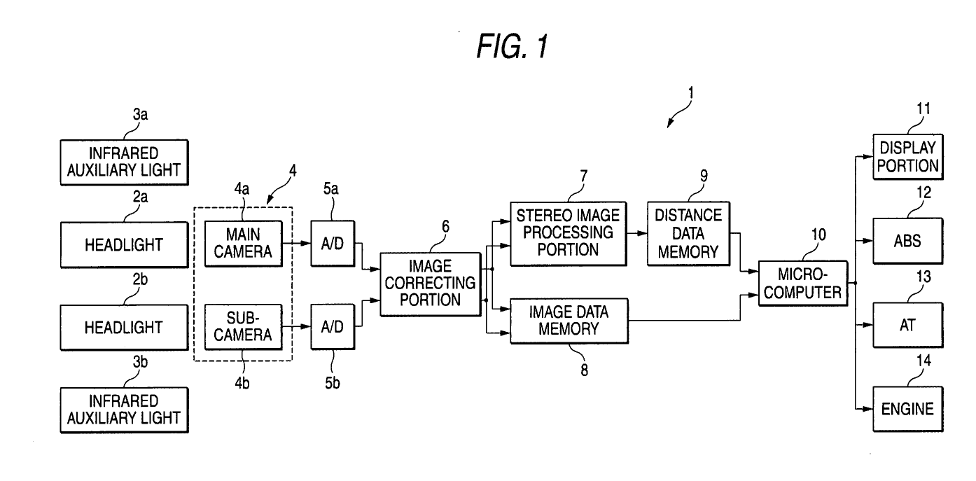

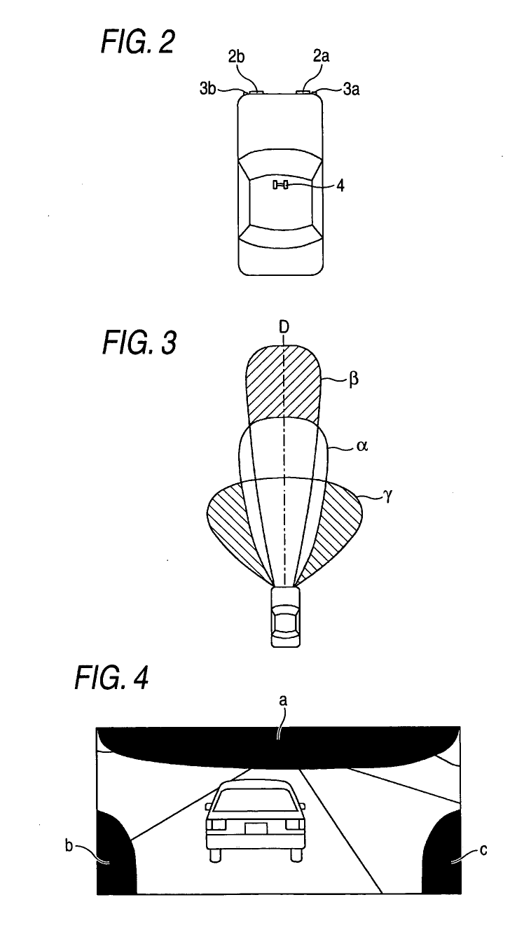

FIG. 1 is a block construction diagram of a stereo vehicle-exterior monitoring apparatus according to an embodiment. A stereo vehicle-exterior monitoring apparatus 1 therein obtains a wider monitored area for monitoring control than the monitored area with a headlight only by operating a headlight and an infrared auxiliary light cooperatively during night driving (that is, during driving under an extremely dark circumstance) when the visibility of the front part of the vehicle thereof is low. As shown in FIG. 2, headlights 2a and 2b serving as floodlight lamps are separately mounted at the left and right of the front part of the vehicle and irradiate visible light to the front part of the vehicle. One infrared auxiliary light 3a is provided near one headlight 2a mounted at the front right part of the vehicle, for example. The other infrared auxiliary light 3b is mounted near the other headlight 2b mounted at the front left part of the vehicle, for example. These infrared auxiliary lights 3a and 3b irradiate infrared light, which is invisible light, more specifically, irradiate near-infrared light. Each of the infrared auxiliary lights 3a and 3b may be implemented by attaching a visible light cut filter to a lamp such as a headlight that irradiates visible light, for example, but may be a near-infrared light LED (Light Emitting Diode).

FIG. 3 is a diagram showing an irradiation pattern example of the headlights 2a and 2b and infrared auxiliary lights 3a and 3b. The headlights 2a and 2b irradiate visible light (including an infrared light component) in the direction of irradiation D substantially equal to the direction of advance of the vehicle. The shown area α is an area of irradiation of visible light by the headlights 2a and 2b. The area β is an area of irradiation of infrared light by one infrared auxiliary light 3a. The auxiliary light 3a for the irradiation area β lights up a more distant place than those lighted up by the headlights 2a and 2b in the direction of irradiation D like the headlights 2a and 2b. Thus, the area β of irradiation of infrared light has a narrower angle of irradiation than the area α of irradiation of visible light and extends farther than the irradiation area α. The area γ is an area of irradiation of infrared light by the other infrared auxiliary light 3b. The auxiliary light 3b for the irradiation area γ lights up a closer place than those of the headlights 2a and 2b with infrared light in the direction of irradiation D like the headlights 2a and 2b. Thus, the area γ of irradiation of infrared light has a wider angle of irradiation than the area α of irradiation of visible light and extends closer than the area α of irradiation. Since the infrared light irradiated by the infrared auxiliary lights 3a and 3b is not visibly recognizable light, a driver driving the vehicle, preceding vehicle or oncoming vehicle does not perceive the irradiation of infrared light in the irradiation areas β and γ, for example.

A stereo camera 4 is mounted near the room mirror inside of the vehicle, for example, and obtains road conditions before the vehicle, monitoring information on an obstacle and so on. The stereo camera 4 includes a pair of infrared cameras 4a and 4b photosensitive to infrared light and shoots the front part of the vehicle under the irradiation of the headlights 2a and 2b and infrared auxiliary lights 3a and 3b. Each of the cameras 4a and 4b contains an image sensor such as a CCD (Charge-Coupled Device) sensor or a CMOS (Complementary Metal-Oxide Semiconductor) sensor. The main camera 4a disposed on the right side in the direction of advance sequentially shoots a reference image for stereo image processing. On the other hand, the sub-camera 4b disposed on the left side in the direction of advance shoots a comparison image in synchronization with the main camera 4a. An analog signal output from the main camera 4a is converted to digital data of predetermined brightness gradation (such as 256 level gray scale) by an A/D converter 5a and is then supplied to an image correcting portion 6 as reference image data. An analog signal output from the sub-camera 4b is converted to digital data by the A/D converter 5b and is then supplied to the image correcting portion 6 as comparison image data.

The image correcting portion 6 performs image correction processing such as correction of intensity and geometric conversion of an image on the reference image data and comparison image data. Generally, shot images are displaced since the positions where the pair of infrared cameras 4a and 4b included in the stereo camera 4 is mounted have an error due to a distortion of the body, for example. In order to correct the displacement, geometric conversion such as a rotation and parallel movement of the images are performed by using Affine transformation, for example. The reference image data and comparison image data for one frame after the image processing are output to the subsequent stereo image processing portion 7 and are stored in an image data memory 8.

The stereo image processing portion 7 calculates distance data relating to a shot image for one frame based on the reference image data and comparison image data. Here, the expression, “distance data” is a set of parallaxes d each calculated for each sub-area (such as 4×4 pixels) on the image plane defined by image data. In order to calculate the parallax d of a (correlating) pixel block in the reference image, the (correlated) area correlated with an intensity characteristic of the pixel block is located on the comparison image. As well known, the distance from the stereo camera 4 to a subject appears as an amount of horizontal displacement between the reference image and the comparison image. Therefore, in order to find the correlated one on the comparison image, the correlated one may be searched on the horizontal line (epipolar line) also having the correlating pixel block. The correlation of two pixel blocks can be evaluated by calculating a city-block distance, for example, and the pixel block with the minimum value is determined as the correlated one. Then, the amount of displacement between the located correlated one and correlating one can be the parallax d. The distance data calculated through the processing, that is, the set of parallaxes d corresponding to positions on the image plane is stored in a distance data memory 9.

A microcomputer 10 recognizes and monitors a subject (such as a preceding vehicle and a pedestrian) present in front of the vehicle based on the distance data stored in the distance data memory 9 and with reference to the image data stored in the image data memory 8 as required. Since the specific subject recognition and monitoring methods have been disclosed by the present applicant in many applications, the description will be omitted herein. The microcomputer 10 may display a real-space position relating to a recognized subject in real time on the display portion 11, for example. The microcomputer 10 may monitor a behavior of the recognized subject and the distance therefrom to the vehicle, for example, and perform brake control over the vehicle through an ABS (anti-lock brake system) 12, an AT (automatic transmission) 13 or an engine 14 as required.

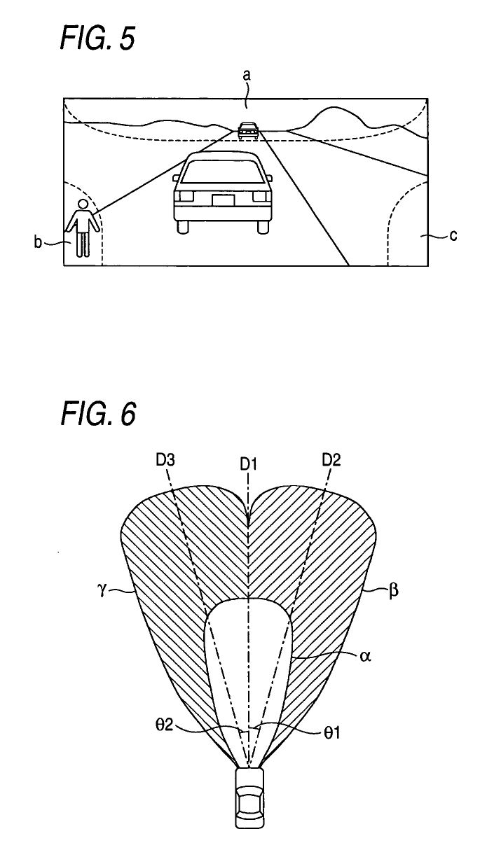

In this way, according to this embodiment, the multiple infrared auxiliary lights 3a and 3b are used to light up a more distant place with infrared light than the place lighted up by the headlights 2a and 2b and light up a closer place with infrared light at a wider angle of irradiation than those of the headlights 2a and 2b. Thus, a wider range of monitored area can be obtained even during night driving than that of the irradiation by the headlights 2a and 2b only. This point will be described in detail in comparison between FIGS. 4 and 5. FIG. 4 is a diagram of a monitored area of the irradiation by the headlights 2a and 2b only, and FIG. 5 is an explanatory diagram of a monitored area when the headlights 2a and 2b and the infrared auxiliary lights 3a and 3b are all used. In the former case, the actually effective monitored area may be limited to the area corresponding to the area α of irradiation of visible light shown in FIG. 3 rather than the entire part within the rectangular frame. In this case, the other areas a, b and c are masked areas where a subject cannot be recognized under monitoring control. Therefore, when a preceding vehicle exists in the far area α, for example, the preceding vehicle may sometimes not be recognized as a subject for monitoring control. Similarly, when a pedestrian exists in the left and/or right vicinities b and/or c of the vehicle, the pedestrian may sometimes not be recognized as a subject. This case becomes more significant under an extremely dark circumstance when almost no light source exists except for the headlights of the vehicle.

On the other hand, since, in the latter case, not only the headlights 2a and 2b but also the infrared auxiliary lights 3a and 3b light, the occurrence of the masked areas a, b and c as shown in FIG. 4 can be effectively suppressed. Thus, even when a preceding vehicle exists in a far area which is not included in the area α of irradiation of visible light, the preceding vehicle can be recognized effectively as a subject as far as the preceding vehicle exists within the area β of irradiation of infrared light. Furthermore, even when a pedestrian exists in the left and/or right vicinities b and/or c excluded in the area α of irradiation of visible light, the pedestrian can be recognized effectively as a subject as far as the pedestrian exists within the area γ of irradiation of infrared light. In this way, a further enhancement of accuracy of monitoring during night driving can be achieved by increasing the monitored area obtained only by the irradiation of the headlights 2a and 2b both farther and closer.

Furthermore, according to this embodiment, a wider range of monitored area can be obtained simply by using the multiple infrared auxiliary lights 3a and 3b without complication of the optical system. Generally, with a single light source, two irradiation characteristics of the angle of irradiation and distance of irradiation have a directly-opposed relationship. The distance of irradiation decreases as the angle of irradiation increases while the angle of irradiation decreases as the distance of irradiation increases. This is also true for the headlight (that is, single light source of infrared light) disclosed in Japanese Patent Published Application JP-A-2003-217319. According to this embodiment, both of sufficient angle of irradiation and sufficient distance of irradiation can be achieved by changing the irradiation characteristics of the multiple infrared auxiliary lights 3a and 3b and complementing one irradiation characteristic with the other irradiation characteristic.

The irradiation pattern for obtaining both sufficient angle of irradiation and sufficient distance of irradiation by complementing is not limited to the one in FIG. 3, but other irradiation patterns may be applicable thereto. FIG. 6 is a diagram showing another irradiation pattern example of the headlights 2a and 2b and infrared auxiliary lights 3a and 3b. The headlights 2a and 2b irradiate visible light in the direction of irradiation D1 substantially equal to the direction of advance of the vehicle. The shown area α is an area of irradiation of visible light by the headlights 2a and 2b. The area β is an area of irradiation of infrared light by one infrared auxiliary light 3a. The auxiliary light 3a irradiates infrared light in the direction of irradiation D2, which is displaced from the direction of irradiation D1 of the headlights 2a and 2b by an angle θ1. Therefore, the irradiation area β of infrared light extends off the irradiation area α to the right in the vicinity of the vehicle and extends farther than the irradiation area α. Furthermore, the area γ is an area of irradiation of infrared light by the other infrared auxiliary light 3b. The auxiliary light 3b irradiates infrared light in the direction of irradiation D3, which is displaced from the direction of irradiation D1 of the headlights 2a and 2b by an angle θ2. Therefore, the irradiation area γ of infrared light extends off the irradiation area α to the right in the vicinity of the vehicle and extends farther than the irradiation area α.

While two infrared auxiliary lights 3a and 3b are used, for example, according to this embodiment, three or more infrared auxiliary lights may be apparently used.

Though this embodiment illustrates the construction example for increasing the monitored area defined for the front part of the vehicle thereof by focusing on the headlights 2a and 2b serving as floodlight lamps, the invention is not limited thereto. The invention is widely applicable to a floodlight lamp that lights up the surrounding of the vehicle. For example, a backlight that irradiates the rear part of the vehicle may be focused and be used in addition to the auxiliary lights 3a and 3b in order to increase the monitored area in the rear part of the vehicle.

What is claimed is:

1. A stereo vehicle-exterior monitoring apparatus comprising:
a floodlight lamp for lighting up the surrounding of a vehicle thereof;
a plurality of infrared auxiliary lights for lighting up a more distant place by infrared light than that is lighted up by the floodlight lamp and for lighting up a closer place and wider angle of lighting by infrared light than that is lighted up by the floodlight lamp so as to obtain a wider monitored area than that with the lighting by the floodlight lamp only;
stereo cameras including a pair of infrared cameras, the stereo cameras shooting at least a lighted range of the infrared auxiliary lights;
a stereo image processing portion for calculating distance data by stereo-matching based on a pair of images shot by the stereo cameras; and
a monitoring portion for monitoring a subject present in the surrounding of the vehicle based on the distance data output from the stereo image processing portion.

2. The stereo vehicle-exterior monitoring apparatus according to claim 1, wherein
the floodlight lamp includes a pair of headlights mounted on the front left and right parts of the vehicle.

3. A stereo vehicle-exterior monitoring apparatus comprising:
a floodlight lamp for lighting up the surrounding of a vehicle thereof;
a first infrared auxiliary light for lighting up a more distant place by infrared light than that is lighted up by the floodlight lamp;
a second infrared auxiliary light for lighting up a closer place and wider angle of lighting by infrared light than that is lighted up by the floodlight lamp;
stereo cameras including a pair of infrared cameras, the stereo cameras shooting at least a lighting range of the first infrared auxiliary light and a lighting range of the second infrared auxiliary light;
a stereo image processing portion for calculating distance data by stereo-matching based on a pair of images shot by the stereo cameras; and
a monitoring portion for monitoring a subject present in the surrounding of the vehicle based on the distance data output from the stereo image processing portion.

4. The stereo vehicle-exterior monitoring apparatus according to claim 3, wherein
the floodlight lamp includes a pair of headlights mounted on the front left and right parts of the vehicle.

5. A stereo vehicle-exterior monitoring apparatus comprising:
a floodlight lamp for lighting up the surrounding of a vehicle thereof;
a first infrared auxiliary light for lighting up a more distant place by infrared light than that is lighted up by the floodlight lamp at right direction with respect to the direction of lighting by the floodlight lamp;
a second infrared auxiliary light for lighting up a more distant place by infrared light than that is lighted up by the floodlight lamp at a left direction with respect to the direction of lighting by the floodlight lamp;
stereo cameras including a pair of infrared cameras, the stereo cameras shooting at least a lighting range of the first infrared auxiliary light and a lighting range of the second infrared auxiliary light;
a stereo image processing portion that calculates distance data by stereo-matching based on a pair of shot images output from the stereo cameras; and
a monitoring portion that monitors a subject present in the surrounding of the vehicle based on the distance data output from the stereo image processing portion.

6. The stereo vehicle-exterior monitoring apparatus according to claim 5, wherein the floodlight lamp includes a pair of headlights mounted on the front left and right parts of the vehicle.
